(19) United States
(12) Patent Application Publication
(10) Pub. No.: US 2017/0242923 A1
(43) Pub. Date: Aug. 24, 2017

(54) DEVICE FOR INTERNET SEARCH OF MUSIC RECORDINGS OR SCORES

(71) Applicant: Vladimir VIRO, Munich (DE)

(72) Inventor: Vladimir VIRO, Munich (DE)

(21) Appl. No.: 15/521,599

(22) PCT Filed: Oct. 23, 2015
(86) PCT No.: PCT/EP2015/025072

§ 371 Date: Apr. 24, 2017

(30) Foreign Application Priority Data
Oct. 23, 2014 (EP) 14020069.2

(51) Int. Cl. G06F 17/30

(52) U.S. Cl. CPC G06F 17/30743; G06F 17/30769; G06F 17/30864

(57) ABSTRACT

There is disclosed a device for internet search of audio of a musical composition in correspondence with its score, the device adapted to: receive from a user an identification of the score and a query for a media search in internet; send the query to a content resolver; receive results of the search; identify, in results of the search, first results, each of which has been previously confirmed as pointing at a media with an audio channel with at least a part of the musical composition; and present to the user all or a part of the first results, if there is at least one first result, articulating them with respect to other results.

### FIELD OF THE INVENTION

The invention is in the field of music information retrieval, in particular, internet search for music recordings and scores, and is aimed at improving efficiency of the retrieval.

### BACKGROUND

In internet there are plenty of portals containing or referencing music. Many music recordings are stored as files available for downloading. For example, different files are stored at archive.org. In many cases, music may be streamed from a portal. For example, streams are provided by such service as soundcloud.com. Also, music often may be found in an audio channel of a video, stored, for example, at such website as youtube.com. Music may be found at a page or a feed of a user at facebook.com or vk.com. Music, for example, in a stream, may be accessible at one portal through embedding from another portal. Music may be provided by a portal to an application or an “app”, for example, with such services as spotify or iTunes. Also, music recordings may be available through a file sharing system, where music recordings or their parts are stored by users. Additionally, music recordings may be accessible for a user through a virtual private network. Any of such differently stored or differently accessible recordings may be an object of the internet search.

There are various content resolvers which may be used for the internet search. Each content resolver searches in its own search space. For example, a content resolver may search for a recording on a specific portal or in a index of shared files. Also, a content resolver may be associated with a search engine such as google.com or bing.com with a broad search space. A content resolver may be accessible by paid or unpaid subscription. A content resolver may be accessed by an internet browser or a specialized application.

Similarly, there are portals or services providing access to music scores and content resolvers for internet search of music scores.

### DETAILED DESCRIPTION OF THE INVENTION

### Introduction

The inventor has noticed that search of music or scores by metadata only, for example by the names of composer and music composition in too many cases brings irrelevant results. This requires from the user to spend more time on the search. Also, the user wastes computing and network resources by attempting to stream or download irrelevant recordings or scores. An automatic search agent, using the keyword or metadata search, and receiving irrelevant results, uses computing and network resources inefficiently.

According to the idea of the inventor, the relevancy of the internet search results can be improved, for recordings of musical compositions played in correspondence with a music score. Also, the search can be more nuanced if it is performed with taking into account the correspondence between the music score and the music recording. For example, if several versions of the musical composition exist, the respective score determining each version, a user may be interested in finding a recording of a performance of a specific version. The technique generally allows reducing the time to be spent on finding relevant media, or score, or both the media and the score.

The improvement, for example, in the relevancy of the search results or time efficiency of the search may be achieved with a database storing, for pointers pointing at media in internet, information on whether one or more musical compositions, corresponding to one or more scores, are indeed present in the audio channel of this media. The database may store a score, or a score may be accessible via internet. In the latter case the database contains information if a pointer, pointing at a media in internet, and a pointer, pointing at a score in internet, point at media and the score corresponding to each other.

With regard to a pointer, and a result of a search in internet with a content resolver, it may be in a form an internet link to the corresponding media or score. Also, it may be in form of a link to a website and an identification of a media or score at this website. If a party, which receives the pointer, has some additional or predefined information about the pointer, for example the receiving party at some point of time acquires the information that the sender's pointers relate to a specific portal, such as youtube.com, then shortened identifications may be understood as pointers (e.g. only the part “JqCwQ9clHec” instead of the longer form www.youtube.com/watch?v=JqCwQ9clHec).

The database generally uses less memory when it is configured so as not to store the media, containing audio. Also, the database uses less memory when it is configured not to store music scores.

When the database has records with pointers pointing at scores in internet, it may be used to facilitate searching for a score matching a certain media. Also, the database may be used for searching for matching pairs of media and score when a user performs a search in internet for both an audio recording and a score of a certain musical composition.

The database may have records added manually, after an operator of the database ascertains the existence of the correspondence between a media in internet and a score.

Also, the database may have records based on databases storing synchronized media and scores. For example, a media and a score from, or referenced in such a synchronization database can be uploaded in internet, while the database built according to the invention is provided with information on pointers for the uploads and confirmation that they correspond to each other. Additionally, the database may store such synchronization data as information on correspondence between segments in the score, for example, bar or notes in the score, and time intervals in the media.

Furthermore, the database may include records for providing confirmation information on whether a media in internet corresponds to a score, where these records are obtained with a use of an optical music recognition technique. For example, the recognized score of the composition may be rendered into standard midi form and compared with an audio channel from the media transcribed into standard midi form. In case the comparison shows that these midi forms are substantially similar, for example differ in less than 50 per cent of notes, it may be accepted that the media corresponds to the score. Alternatively or additionally, the recognized score may be rendered into some other common form, into which the audio channel will also be transcribed. The acceptance criterion for existence of the correspondence between the score and the media depends on the amount of noise which is acquired during such processing.

The scores may in a staff notation. The staff notation may be a modern staff notation. The staff notation may be a Western staff notation.

A user may inquire the database, stored at the user device and/or at a classification server, to determine which of media, found by internet search for media initiated by the user, include a musical composition corresponding to an identified score. Those search results, for which the database stores a confirmation of this sort, become confirmed results. In this document, such confirmed results of the search at times will be called first results. In some cases, however, confirmed or first results exclude pointers which provide no access to the media containing a musical composition corresponding to the identified score due to a restriction.

The database may be stored at a server and updated by receiving pointers from users or from content resolvers, in particular, search engines. For example, the user may send to the database results of a media search performed with a search engine, such as google.com, bing.com or youtube.com, the latter searching for media at its own website. In some cases, these results will include pointers on which the database will not have records. Such search results will be called second results. New records then may be created in the database, after the media referenced by such a pointer is analyzed and it is established if the media corresponds to one or more score. For example the presence or absence of the correspondence may be checked for a score, whose pointer, or another identification, will be provided to the server by the user.

Alternatively, the user may perform the search using content resolvers indirectly, by transmitting the queries to a classification server storing the database, which will further transmit the queries to one or more search engine, receive results of the search, and identify the first, second and other results. With such indirect search, the classification server will regularly receive pointers for which the database has no records on the correspondence between the audio and the score. This will allow adding data to the database and keeping it up-to-date.

The database, or its part, may be stored at the user's device, such as computer, including laptops, tablet personal computers, and smart phones.

Additionally, the database may store records confirming an absence of correspondence between a media pointer and a score or a score pointer. If results returned by the search engine or another content resolver include such media pointers, the database may be used to indicate to the user that these results are less relevant than other results. Such results will be called third results. In some cases they will include pointers which provide no access to the media containing a musical composition corresponding to the identified score due to a restriction.

Third results, for example, may be filtered out and not presented to the user, and/or they may be marked, for instance, highlighted or colored, differently from the other results, and/or they may be given last numbers in the search result list, and/or they may be presented in smaller areas on the display, and/or with smaller letters, and/or they may be given peripheral positions on the display or in the area used for presentation of the results. In other words, during the presentation of results of the search to a user, other results may be articulated with respect to the third results.

Additionally or alternatively, the first results may be articulated with respect to the second results, for example, presented before the second results in time, and/or put on the first positions in a numbered list of results, and/or marked differently from the second results. Also, a first result may be articulated by presentation in an area of a bigger size, for example, as a bigger video window, and/or it may be presented in a more central position on the display or in the area of the display used for presentation of results, and/or it may be presented in bigger letters.

However, it should be noted that presenting the results of the search to the user, while articulating some of them with respect to others is a nonessential step for the technique of the inventor. The technique may be beneficially used as soon as there is created a record accessible or manageable by the user and which specifies for at least one result found by the content resolver if this result is, for example, a first result. Even if the user is provided with search results where no group is articulated with respect to other results, she or he can save resources needed for downloading or streaming the audio or the score if the user can select confirmed results or avoid selecting irrelevant results. Also, the user device, or another device to which the user may send the list of results, may be equipped with software reading the records, specifying whether the results is for example, a first result (or a second, or a third result). The device may be configured to automatically download or stream the audio or score, on which the result points, when the device receives the first result. Alternatively or additionally, the device may use software making it avoid downloading or streaming the audio or score when the device receives the third result. Information that the result is a second result may be beneficially used, for example, in a situation when the user would rather save the resources and not use unconfirmed results.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples. Similar or corresponding details of the various devices generally have identical reference numerals. In the following drawings:

FIG. 1 schematically shows a system for search of music recordings, according to the present technique, wherein the features of this system are found also in some other examples of the present technique;

FIG. 2 schematically shows another system for search of music recordings, according to the present technique, wherein the features of this system are found also in some other examples of the present technique;

FIG. 3 schematically shows yet another system for search of music recordings, according to the present technique, wherein the features of this system are found also in some other examples of the present technique;

FIG. 4 schematically shows a system for search of recordings of musical composition and corresponding scores, according to the present technique, wherein the features of this system are found also in some other examples of the present technique;

FIG. 5 schematically shows another system for search of recordings of musical composition and corresponding scores, according to the present technique, wherein the features of this system are found also in some other examples of the present technique;

FIG. 6 schematically shows yet another system for search of recordings of musical composition and corresponding scores, according to the present technique, wherein the features of this system are found also in some other examples of the present technique;

FIG. 7 schematically shows yet another system for search of recordings of musical composition and corresponding scores, according to the present technique, wherein the features of this system are found also in some other examples of the present technique;

FIGS. 8 and 8A provide an example of device display, according to the present technique;

FIG. 9 schematically shows yet another system for search of music recordings, according to the present technique, wherein the features of this system are found also in some other examples of the present technique;

FIG. 10 schematically shows yet another system for search of music recordings, according to the present technique, wherein the features of this system are found also in some other examples of the present technique.

### DETAILED DESCRIPTION BASED ON THE DRAWINGS

The illustrated embodiments of the present invention will be described with reference to the figure drawings wherein like elements and structures are indicated by like reference numbers.

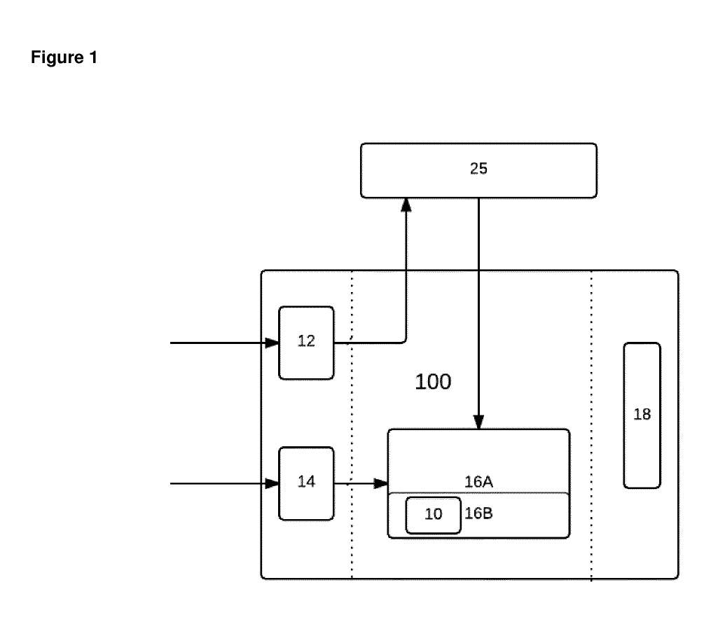

With reference to FIG. 1, there is schematically shown an example of a device 100 for internet search of audio of a musical composition in correspondence with its score. Device 100 receives from a user a query for a media search in internet and an identification of the score, and stores these data in memory cells 12 and 14, respectively. These data may be received, for example, via a conventional electromechanical or virtual keyboard, a touchscreen, and/or it may be received with the use of a mouse, touchpad or another pointing device. Also, voice input may be used. Device 100 sends the query to a content resolver 25 and receives from it results of the search. Device 100 then uses a processing unit 16A and recorded database 10 in memory 16B to identify or select, in results of the search, those results, each of which has been previously confirmed as pointing at a media with an audio channel with at least a part of the musical composition. Such results may be called “first results”. Thus, the user device may store at least a part of the database described above. Consequently, device 100 may present, at its output unit 18, all or a part of the first results, articulating them with respect to other results. The output unit 18 may be constituted, for example, by a display or a screen. It should be noted that the step of presenting the results is possible without the step of articulating the results, and that both these steps are not essential and can be missed.

Of course, from time to time it may occur that among the results of the search there are no confirmed results. In such cases articulating of the first results is not performed. Also, it may occur that all results of the search are confirmed results. In such cases articulating is not performed as well, but it may be indicated, when results are presented to the user, that results are confirmed results.

Generally, if a group of the first results, or a group of the second results is presented to the user, the results may be sorted within the group according to one of the known methods. For example, the ordering may be performed based on a total number of views of the videos. Also, the ordering may be performed with a method based on use of the synchronization database. For example, results within the group may be sorted based on a number of views of the video, where those views, which occurred after each viewer was informed about whether the video is a “confirmed” result with respect to the searched composition, are taken into account. Also, an accumulated duration of viewing by different viewers, instead or in addition to the number of views may be used for ordering results within their respective group.

When search results are presented, in particular, displayed, they may be shown in different forms. For example, search results from youtube.com are typically shown as video windows, where a click is required to start the video playback. However, the user device obtains a recording from youtube.com using some pointer. Also, clicking does not need to be required: in many cases, videos which appear in feeds at facebook.com are played automatically as soon as the user opens or scrolls a relevant page.

Generally, displaying is one of the most preferred methods of presentation for scores, and playing, as an audio, is typically the preferred method of presentation for music recordings. Accordingly, the user device may be equipped with software displaying image files and/or playing audio files or audio channels of video files so as to allow the user to follow the score pointers or media pointers.

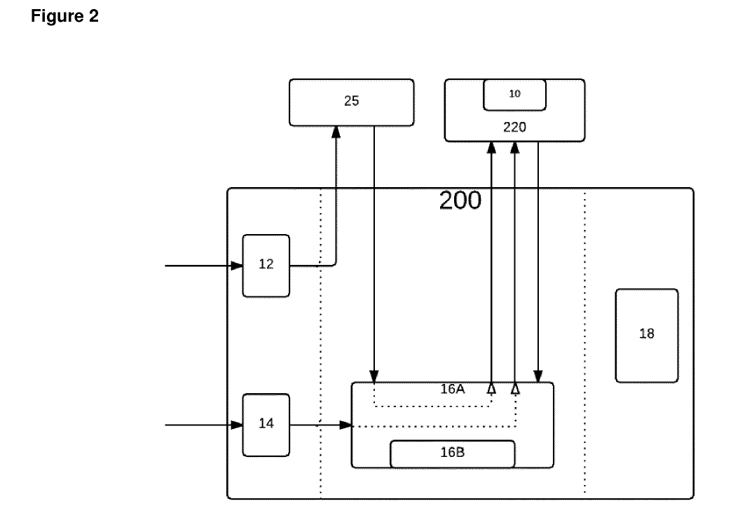

With reference to FIG. 2, there is shown another example of a device 200 for internet search of audio of a musical composition in correspondence with its score. Device 200 is different from device 100 in that it sends at least a part of the results of the internet search, along with the identification of the score, to a classification server 220 including database 10 and identifying or selecting, in the received results of the search, those results, each of which has been previously confirmed as pointing at a media with an audio channel with at least a part of the musical composition. The server 220 then sends to the user device 200 an indication allowing the user to determine one or more previously confirmed result, if there are such results in the received results. For example, if almost all of the results received by the server are confirmed results, the server may send to the user a list with numbers of the unconfirmed results, along with an indication that the sent numbers are the numbers of the unconfirmed results.

While in FIG. 2 device 200 does not have records on previously confirmed pointers or results in memory 16B, the device may have such records in further examples based on FIG. 2. In some cases, only a part of the database 10, stored at classification server, is stored in memory 16B. For example, a number of most frequently used previously confirmed results may be stored at the user's device. Thus, the user device may be adapted to report the identification of the musical score and a part of the results, on which no confirmation is stored locally, to the classification server and receive a classification report on at least a part of the reported results for presentation of the results to the user with articulation of the results which have been confirmed either locally or by the classification server.

Thus, with regard to the classification server 220 facilitating internet search of audio of a musical composition in correspondence with its score, it is adapted to receive from a user device an identification of the score and results of a media search, and identify, in results of the search, first results, each of which has been previously confirmed as pointing at a media with an audio channel with at least a part of the musical composition. The server then can inform the user on all or a part of the first results. The server stores a part of or whole database 10. The server is of course an apparatus with an input/output network interface, a processing unit, and a memory.

Actually, in general case, the server may not be informed about the fact that the pointers, which it receives, are results of some search. The server may perform its analysis for a set of media pointers which were obtained in some other way rather than the search.

In the above examples, as well as in the following examples, the user device 100 and 200, or server 220 may be configured not to include into the first results those results which provide no access for the user to said media. For example, for a certain pointer pointing at a media, the database may store identifications of scores of compositions which are played in the media. However, the media may be not accessible to certain users due to age or location restrictions. Consequently, the database may include records about the restrictions, for excluding presentation of results inaccessible to the user as first results, which are to be articulated.

Referring now again to FIG. 1, the user device 100 may be configured to be connected to a classification server as well. The user device may send to the classification server the score identification and those results, for which no confirmation with regard to the pointer has been previously obtained, i.e. the second results. At the classification server it may be checked whether the pointers, received from the user device, point at media with an audio channel with at least a part of the musical composition. In particular, it may occur that for some of the pointers it will be confirmed that they point at recordings of the music composition corresponding to the identified score.

This allows the classification database to grow and stay up-to-date. The classification database, or a part of it, may be downloaded to the user device 100 after the update, or it may be used for other user devices, as in the examples based on FIG. 2. Consequently, the second results may be re-classified as the first results. For example, if the user still uses the results of the internet search, by opening another page with them, the reclassified first results may be presented in the articulated way with respect to other results on a new page.

The database may be updated in the examples based on FIG. 2 as well. In particular, the same kind of check may be performed for pointers obtained by the user as results of the internet search, sent to the classification server 220, and not classified as first results by the classification database at the server 220. Updating the database is beneficial for futures uses. Hence, for instance, in the example of FIG. 2, the step of informing device 200 on classification of the search results is not essential.

The database, in all examples, may be updated also by subscribing the classification server to a feed describing new uploads to a certain portal. For example, for any media, the classification server may check if this media corresponds to any of the scores, whose identifications are stored by the server and which are accessible to the server.

The classification database may classify pointers into more categories. In examples based on FIGS. 1 and 2, the classification database, entirely stored at the user device 100, or entirely stored at the classification server 200, or in part stored at the user device and in part stored at the classification server, where these parts may intersect, may store records on pointers which have been previously confirmed as providing no access for the user to media with an audio channel with at least a part of musical composition, for various musical compositions, or, rather, score identifications. These pointers may include pointers which point at media with an audio channel with at least a part of the musical composition, but are not accessible to the user due to restrictions, as mentioned above. Also, these pointers may include pointers which appear in searches for some composition, but do not contain this composition. For example, a video at youtube.com may contain the first concerto of a composer, but be titled “First Symphony” due to a mistake of the person who uploaded it. Alternatively, a video may contain a First Violin Sonata, but be titled “First Sonata” and appear in results of the search for a First Piano Sonata.

When the user performs the internet search, and the results are classified using such classification database, first results are to be articulated with respect to other results. However, the second results, if found, may be articulated with respect to the third results. The third results may even be not shown at all.

Also, the second results may be re-classified not only as the first results, but as the third results as well, depending on the outcome of the check described above.

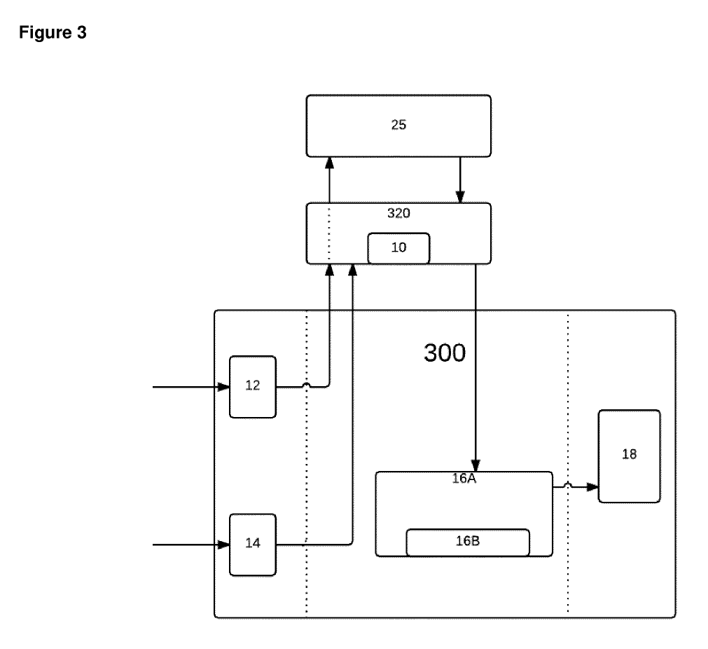

With reference to FIG. 3, there is schematically shown another example of a user device 300 for internet search of audio of a musical composition in correspondence with its score. Device 300 differs from device 200 in that adapted to send both the query for a media search in internet and the identification of the score, received from the user, to a classification server 320. Server 320 then sends the query to the content resolver 25, and receives results of the search. As in the examples based on on FIG. 2, the classification server identifies in results of the search previously confirmed, first, results, pointing at media with an audio channel with at least a part of the musical composition. The user device then receives and presents to the user at least a part of the first results from the classification server, if there is at least one first result. Presented first results are articulated with respect to other results.

Of course, the first results may exclude those pointers, which provide no access for the user to media with an audio channel with at least a part of the musical composition, for example, due to restrictions.

Also, device 300 may receive from server 320 second results, for each of which the synchronization database utilized by the server 320 has no record on confirmation on whether the pointer, corresponding to the second results, points on a media with audio of the musical composition. The second results may be articulated to the third results, which, however, may not be sent to the device 300 from server 320.

The devices in examples based on FIGS. 1-3 may be adapted for internet search of a score of a musical composition in correspondence with a media including an audio channel with at least a part of the musical composition, rather than for search of the media. In such cases, the user device receives from a user an identification of the media and a query for a score search in internet.

For instance, in an example similar to the example shown in FIG. 1, the user device, as above, sends the query to a content resolver; receives results of the search; identifies, in results of the search, first results, each of which has been previously confirmed as pointing at a score with at least a part of the musical composition; and presents to the user all or a part of the first results, if there is at least one first result among the results of the search, articulating them with respect to other results.

However, there is a difference in that the results, provided by the content resolver, should point at scores rather than media. Also, in the examples based on FIG. 1, processing unit 16A sends to the database queries based on media pointers. In the present example, the processing unit sends to the database queries based on score pointers. Hence, the database may be arranged differently in the user device for searching for scores and in the user device 100 for searching for media.

Similarly to the examples based on FIGS. 1-3, when the device is configured for score search, as in the present example, first results may exclude those pointers which have been confirmed to provide no access for the user to a score with at least a part of the musical composition, for example, due to restrictions.

It should be noted that all examples based on FIGS. 1-3 can be transformed into examples for search of music scores. These examples for search of music scores are regarded as part of the technique proposed by the inventor as well. The user device, the classification server, or a system of the user device and the classification server may be claimed in each example.

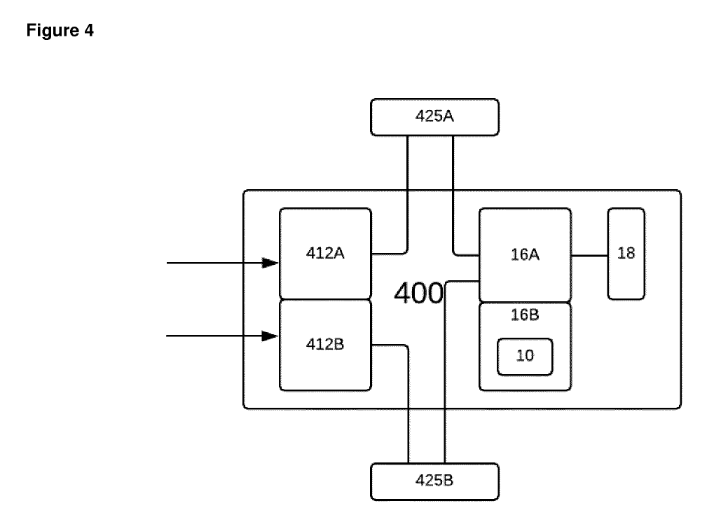

With reference to FIG. 4, there is shown a device 400 for internet search of audio of a musical composition and a corresponding score. Device 400 receives from a user a query for a media search in internet and a query for a score search in internet, and stores these data in memory cells 412A and 412B, respectively. Device 400 then sends the respective queries to a content resolver 425A for the media search and to a content resolver 425B for the score search and receives results of the media and the score searches. Device 400 identifies, in results of the media search and of the score search, confirmed matching pair results, in which the media search result has been previously confirmed as pointing at a media with an audio channel with at least a part of the musical composition corresponding to the score search result. If at least one confirmed matching pair result is found in the results of the search, device 400 presents it to the user, articulating it with respect to non-matching results. Hence, matching pair results are the “first” results in this example.

If in a matching pair the media pointer provides no access for the user, for example, due to a restriction, such matching pair may be excluded from the first results. Similarly, if in a matching pair the score pointer provides no access for the user, for example, due to a restriction, such matching pair may be excluded from the first results.

It should be noted that presenting a matching pair to the user may be performed by presenting only on search result or pointer from the matching pair. In some cases, there will be also an indication that the presented search result, for example, a media pointer, belongs to the matching pair.

Within a group of the first results, the results may be ordered, for example, by a composite rating. The composite rating may be equal to a sum of logarithm of a number of views pertinent to the media search result and of logarithm a number of views pertinent to the score search result.

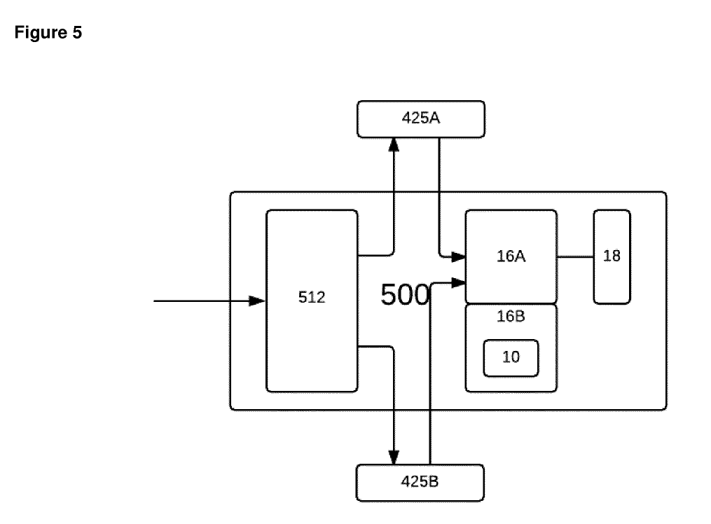

Also, it should be noted that the user device may be configured to receive the same query from the user for the media search and the score search. Such device is schematically shown in FIG. 5 as a device 500.

The examples based on FIG. 4 are similar to the examples based on FIG. 1 in that the identification of the first results is performed at the user device.

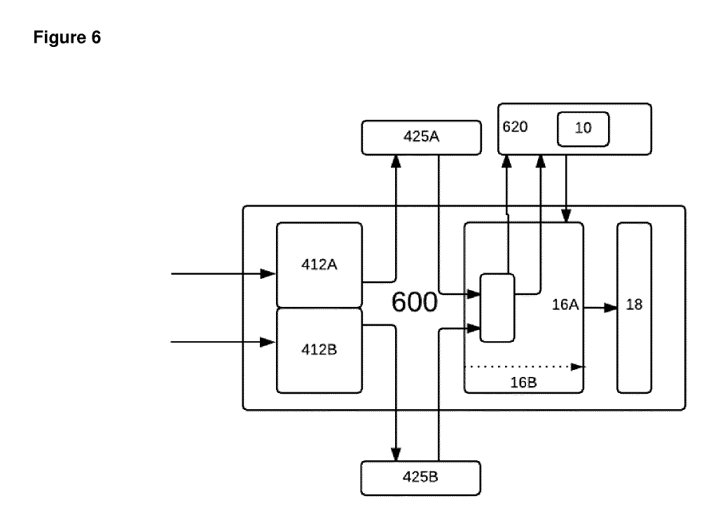

Referring to FIG. 6, there is shown an example in which the identification of the first results is performed at a server 620, for facilitating an internet search of audio of a musical composition and a corresponding score. In FIG. 6, an arrow directed from server 620 to user device 600 signifies that the server sends a list of paired results to the user, where one result in the pair identifies to the user an audio, and the other result identifies a score for the same musical composition. In this example, and in similar cases, the results sent to the users do not need to be “full” pointers, as they can refer to the lists of pointers received from the user. For example, the server 620 can send to the user a pair (2, 4). This would mean that the second pointer in the list of media pointers sent from device 600 to server 620 and the fourth pointer in the list of score pointers sent from device 600 to server 620 correspond to the same musical composition, and an audio channel in a media, at which the media pointer #2 points, contains an audio recording of this composition played according to a score, at which score pointer #4 points. The examples based on FIG. 6 are similar to the examples based on FIG. 2 in that at least in some cases the identification of the first results is performed at the classification server.

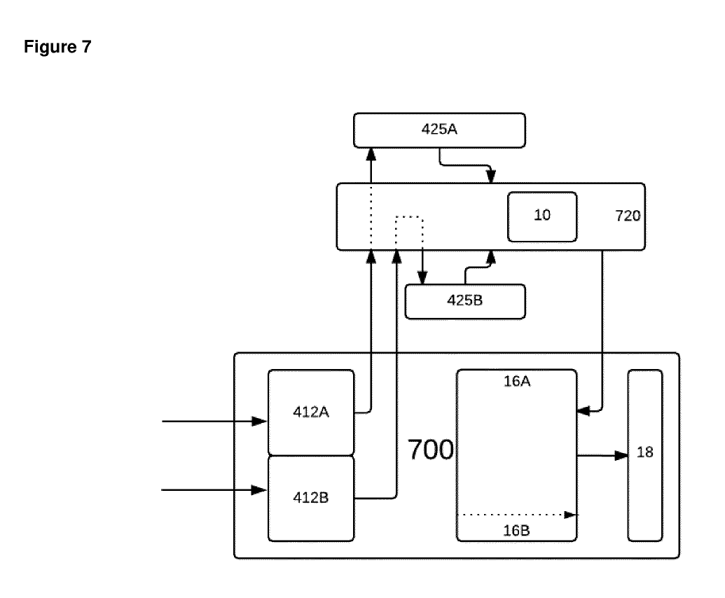

Referring to FIG. 7, there is shown an example in which a server 720, facilitating an internet search of audio of a musical composition and a corresponding score, receives the queries from the user, sends them to appropriate content resolvers, and identifies first results. The examples based on FIG. 7 are similar to the examples based on FIG. 3.

In all examples in this document, the media may be, for example, a video stream or an audio stream.

Also, in all examples, the user device may be adapted to present, for a result selected by the user from the presented first results, at least the audio channel of the corresponding media. For example, if the result leads to a video including an audio recording of the desired music composition, the device, having a screen, may play the audio while not displaying the video, for example due to the absence of an appropriate codec. Also, the device may be adapted to present the media including all its channels.

Also, in all examples, the user device may be adapted to show, for a result selected by the user from the presented first results, a corresponding score. The device may be adapted to receive the score from a remote server in reply to a query, based on the score identification by the user, or it may receive the score by using a search result pointing at the score.

The remote server, from which the score may be received, may be the classification server.

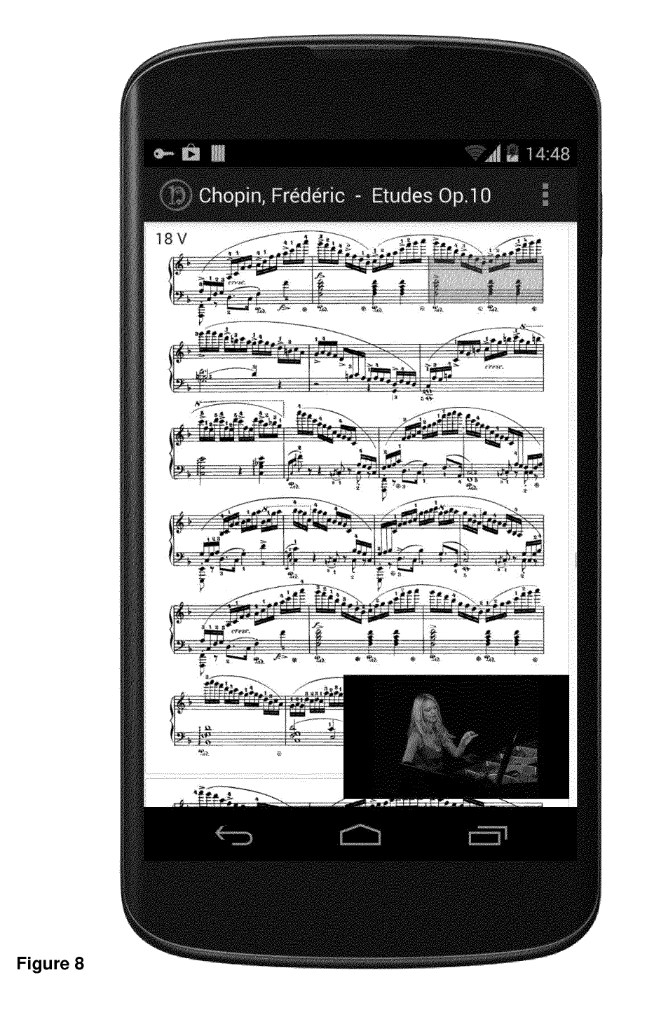

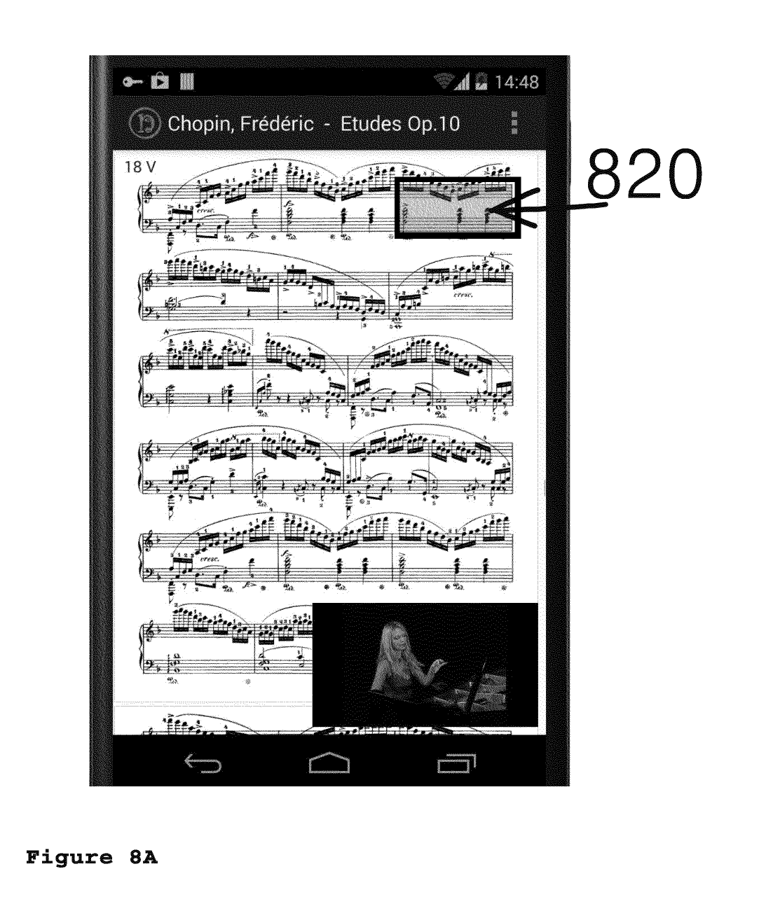

In all examples, the device may receive synchronization data for a media and/or score from the first results or confirmed matching pair results. The device then may play at least the part of the musical composition from the audio channel of the media in a synchronized manner with presenting a relevant part of the score. Presenting the media and the score in the synchronized manner may be performed by highlighting a measure (or a page, a bar, a line, a note) in the score when this segment is being played. With reference to FIGS. 8 and 8A, there is shown an example of a device screen at an instant in which presenting the media and the score in the synchronized manner is performed by marking a measure in the score when this measure is being played. The device for internet search may be a mobile phone, and the display in FIG. 8 corresponds to the mobile phone display. FIG. 8 corresponds to a situation in which the measure is highlighted on the display; therefore the measure in the upper right corner of the display in FIG. 8 is shaded. In FIG. 8A the shaded area is marked by a box or frame 820; however, this frame covers several notes in the score and therefore it should be remembered that it does not appear on the actual display.

Further, the device may allow user navigation in the score of the composition while maintaining playing the media in the synchronized manner with the score. For example, the navigation may be performed by allowing the user to select a segment in the score, whereby the selection causes the device to switch to playing the selected segment in the musical composition.

Alternatively or additionally, the device may allow user navigation in the media while maintaining presenting the corresponding score in the synchronized manner. For example, the navigation may be performed by pulling a slider controlling playback position within the recording. The slider may be shown on a screen of the device, but it may be hidden when it is not in use. In some cases, the slider may appear on the screen when a cursor or a pointer echoing movement of a pointing device, such as mouse or touchpad, is moved to a region where the media window is displayed in the screen of the device. With regard to the devices, which project light on an external surface, for example, a wall in the room, their projection area is considered to be the screen or display.

In all of the examples, the query for the media search and/or for the score search, may be re-sent by the user device or server communicating with the content resolver. Accordingly, updated results of the search may be received. The updated results may be different from the results of the previous search due to an upload of a media to internet by a party different from the user of the user device or the operator of the classification server. In particular, the party which uploads the media may have restricted rights for operations with the classification server, in comparison with the operator of the server.

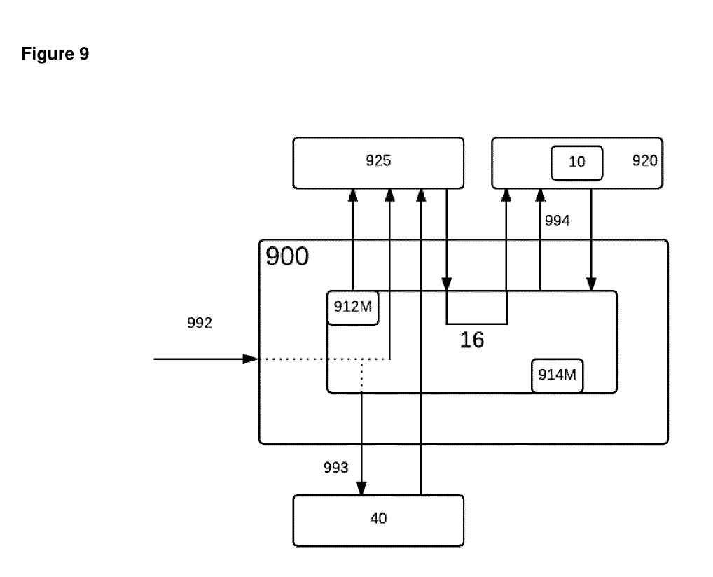

With reference to FIG. 9, there is schematically shown a device 900 for internet search of an audio of a musical composition. The device may present the found audio together with a corresponding score. The device does not require from the user to identify a score. Also, the device does not require from the user to formulate a search query. Rather, device 900 may receive from a user a selection of a musical composition. The score and the query can be defined by the device or a server, for example, the classification server.

The selection of the musical composition can be done, for example, with a menu or a series of menus: for instance, the user initially is provided with a menu for selection of a composer; then, the user is provided with a menu for selection of a form of the composition, such as symphony, concerto, sonata: afterwards, the user is provided with a menu for selection of a number or a title for the selected form, e.g. symphony #5. Also, the user may be provided with an option to select a specific part of the opus, the part thus being understood as a composition.

With regard to the query, the device may store at least one predefined query for a media search in internet for the selected composition. In FIG. 9 the device 900 stores predefined queries in memory 912M. Alternatively or additionally, the device may generate at least one query for a media search in internet based on the selected composition, for instance, by concatenating the menu choices selected by the user. In FIG. 9 such a generation is schematically shown with arrow 992. Also, the user device may request a server 40 to provide at least one query, based on the selected composition. In FIG. 9 such a request is schematically shown with an arrow 93. Also, the user device may receive a query for a media search in internet from the user, but such option is not necessary, as mentioned above. Thus, device 900 may send one or more query to a content resolver 925. Actually, the user device may send its queries to more than one content resolvers. In such case, not all queries have to be sent to each content resolver.

The user device then can receive results of one or more media searches. The device then can send at least a part of the received search results and an identification of a score of the selected musical composition to a classification server, and receive from the classification server an indication of which of the sent results are first results pointing at media with an audio channel with at least a part of the musical composition. The step of sending the identification of the score to the classification server is schematically shown with an arrow 994 in FIG. 9. The identification of the score may be obtained, for instance, from memory 914M of the user device.

It should be noted that the technique, in which the user device receive from the user a selection of a musical composition and does not require from the user a search query and/or identification of a score, is applicable to other examples, such as based, for instance, on FIGS. 1-7.

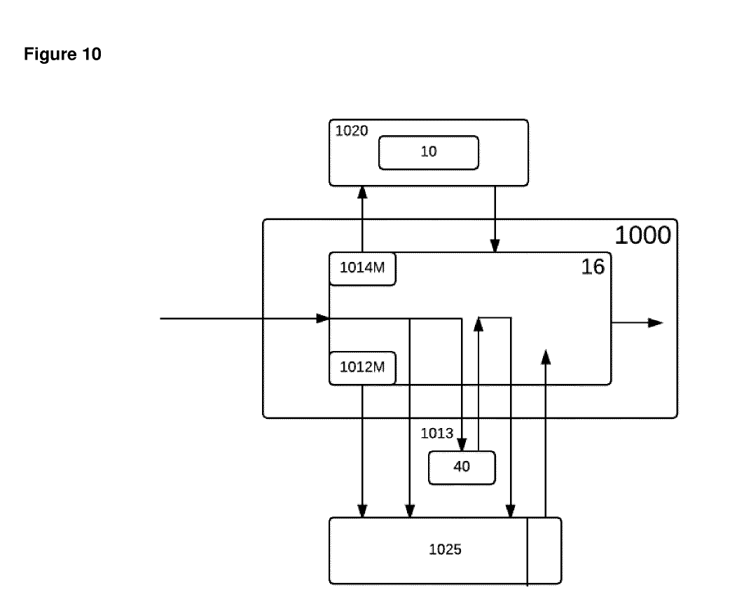

With reference to FIG. 10 there is shown yet another example of a user device 1000 for internet search of an audio of a musical composition. The device may present the found audio together with a corresponding score. Device 1000 receives from a user a selection of a musical composition, as in previous example, but it may instead receive from the user directly an identification of a score.

Device 1000 is generally similar to device 200, however it may be more time efficient. Device 1000 sends to a classification server 1020 an identification of a score for the selected musical composition, and receives from the classification server a list of pointers pointing at media with an audio channel with at least a part of the musical composition. Device 1000 does not have to wait for a response from content resolver before it sends its inquiry to the classification server, and vice versa. Hence, device 1000 send one or more queries for the selected composition to one or more content resolver 1025 and receives results of the at least one search. Device 1000 find first results by selecting pointers which appear in the received results of the at least one search and at the same time in the list of pointers received from the classification server 1020.

It should be noted that the examples based on FIG. 2 or FIG. 6 may use substantially the same method of using the classification server.

Hence, in Aspect 1, there is disclosed:
A device for internet search of audio of a musical composition in correspondence with its score, the device adapted to:
receive from a user an identification of the score and a query for a media search in internet;
send the query to a content resolver;
receive results of the search;
identify, in results of the search, first results, each of which has been previously confirmed as pointing at a media with an audio channel with at least a part of the musical composition; and
present to the user all or a part of the first results, if there is at least one first result, articulating them with respect to other results.

In Aspect 2, there is provided:
A device for internet search of audio of a musical composition in correspondence with its score, the device adapted to
receive an identification of the score and a query for a media search in internet;
send the query to a content resolver;
receive results of the search;
identify, in results of the search, first results, each of which has been previously confirmed as pointing at a media with an audio channel with at least a part of the musical composition, and has not been previously confirmed as providing no access for the user to said media; and
present to a user all or a part of the first results, if there is at least one first result, articulating them with respect to other results.

In Aspect 3, there is provided:
The device of Aspect 1 or 2, wherein the device is adapted to identify second results, for each of which no confirmation with regard to the pointer has been previously obtained.

In Aspect 4, there is provided:
The device of Aspect 3, wherein the device is adapted to identify, among the results of the search, third results, each of which has been previously confirmed as providing no access for the user to media with an audio channel with at least a part of the musical composition.

In Aspect 5, there is provided:
The device of Aspect 4, wherein the results include internet links to corresponding media.

In Aspect 6, there is provided:
The device of Aspect 4 or 5, wherein the results include a link to a website and an identification of a media at this website.

In Aspect 7, there is provided:
The device of any of Aspects 4-6, adapted to perform the identification, in the results of the search, of at least a part of the first results by inquiring a database stored at the device.

In Aspect 8, there is provided:
The device of any of Aspects 1-7, wherein, in an absence of locally stored classification for a part of the results of the search, the identification of at least a part of the results is attempted by inquiring a classification server, wherein the identification of the score and the at least a part of the results of the search is sent to the server in the inquiry.

In Aspect 9, there is provided:
The device of any of Aspects 4-8 adapted to report at least a part of the second results and the identification of the musical score to a classification server for classifying at least a part of the reported results as first results or third results.

In Aspect 10, there is provided:
The device of the previous Aspect adapted to re-identify at least a part of the reported second results as first or third results based on a response from the classification server.

In Aspect 11, there is provided:
The device of the previous Aspect adapted to present to the user all or a part of the re-identified first results articulating them with respect to remaining second results and third results.

In Aspect 12, there is provided:
The device of any of Aspects 4-11 adapted to prevent a presentation of the third results to the user.

In Aspect 13, there is provided:
The device of any of Aspects 4-12 adapted to present at least a part of the second results before the third results.

In Aspect 14, there is provided:
The device of any of Aspects 4-13 adapted to present, for a result selected by the user from the presented results, a corresponding media.

In Aspect 15, there is provided:
The device of the previous Aspect, wherein said corresponding media is a video stream.

In Aspect 16, there is provided:
The device of Aspect 14, wherein said corresponding media is an audio stream.

In Aspect 17, there is provided:
The device of any of Aspects 4-16 adapted to present the score of the composition to the user.

In Aspect 18, there is provided:
The device of the previous Aspect wherein the device is adapted to receive the score from a remote server in reply to a query, based on said identification of the musical composition by the user.

In Aspect 19, there is provided:
The device of the previous Aspect wherein the remote server coincides with said classification server.

In Aspect 20, there is provided:
The device of any of Aspects 17-19 adapted to receive synchronization data for a media from the first results, and play the at least the part of the musical composition from the audio channel of said media in a synchronized manner with presenting a relevant part of the score.

In Aspect 21, there is provided:
The device of previous Aspect wherein presenting in the synchronized manner comprises highlighting a measure in the score when this measure is being played.

In Aspect 22, there is provided:
The device of any one of Aspects 20 or 21 wherein the device is adapted to allow user navigation in the score of the composition while maintaining playing said media in the synchronized manner.

In Aspect 23, there is provided:
The device of the preceding Aspect, wherein the user navigation is performed by selecting a segment in the score thereby causing the device to switch to playing the musical composition from the corresponding segment.

In Aspect 24, there is provided:
The device of any one of Aspects 20-23 wherein the device is adapted to allow user navigation in said media while maintaining presenting the score in the synchronized manner.

In Aspect 25, there is provided:
The device of the previous Aspect wherein said navigation may be performed by pulling a slider shown on a screen of the device.

In Aspect 26, there is provided:
The device of any of preceding Aspects wherein the score is in a staff notation.

In Aspect 27, there is provided:
The device of the previous Aspect wherein the staff notation is a modern staff notation.

In Aspect 28, there is provided:

The device of Aspect 26 or 27 wherein the staff notation is a Western staff notation.

In Aspect 29, there is provided:
The device of any of Aspects 4-28, wherein a result, providing a pointer to media with an audio channel with at least a part of the musical composition, is identified as belonging to the third results due to the user being at a network location from which the media is not accessible.

In Aspect 30, there is provided:
The device of any of Aspects 4-29, wherein a result, providing a pointer to media with an audio channel with at least a part of the musical composition, is identified as belonging to the third results due to the user being not authorized to access the media.

In Aspect 31, there is provided:
The device of any of Aspects 4-30 wherein results are numbered in the presentation and said articulating comprises providing said first results smaller numbers.

In Aspect 32, there is provided:
The device of any of Aspects 4-31 wherein said articulating comprises presenting said all or the part of the first results before the second and the third results.

In Aspect 33, there is provided:
The device of any of Aspects 4-32 wherein said articulating comprises marking said all or the part of the first results in the presentation of the results.

In Aspect 34, there is provided:
The device of any of Aspects 4-32 wherein said articulating comprises marking all of the first results, and, with different marks, at least a part of the second and third results.

In Aspect 35, there is provided:
The device of any of Aspects 4-34 wherein the content resolver is an internet search engine.

In Aspect 36, there is provided:
The device of any of Aspects 4-35 wherein the device is adapted to repeat sending the query for the media search to the content resolver and receive updated results of the search.

In Aspect 37, there is provided:
The device of Aspect 36, wherein the updated results are different from the previous results due to an upload of a media to internet by a different party.

In Aspect 38, there is provided:
A server for facilitating an internet search of audio of a musical composition in correspondence with its score, the server adapted to receive an identification of the score and a collection of pointers pointing at media,
identify, in said collection, first results, each of which has been previously confirmed as pointing at a media with an audio channel with at least a part of the musical composition; and
identify to a user device all or a part of the first results.

In Aspect 39, there is provided:
A server for facilitating an internet search of audio of a musical composition in correspondence with its score, the server adapted to receive from a user device an identification of the score and a collection of pointers pointing at media,
identify, in said collection, first results, each of which has been previously confirmed as pointing at a media with an audio channel with at least a part of the musical composition and has not been confirmed as providing no access for the user device to a media with an audio channel with at least a part of the musical composition; and
identify to the user device all or a part of the first results.

In Aspect 40, there is provided:
The server of Aspect 38 or 39, the server adapted to identify, in the results of the search, second results, for each of which no confirmation with regard to the pointer has been previously obtained.

In Aspect 41, there is provided:
The server of Aspect 40 adapted to identify, in the results of the search, third results, each of which has been previously confirmed as providing no access for the user to a media with an audio channel with at least a part of the musical composition.

In Aspect 42, there is provided:
The server of the previous Aspect wherein the identification of the results is performed by inquiring a database.

In Aspect 43, there is provided:
The device of Aspect 41 or 42 wherein the server is adapted to receive a report on results identified as second by the user, and in an absence, for one or more results, of a record in the server's database identifying the result as first or third, initiate classifying said result as first or third for updating the database.

In Aspect 44, there is provided:
The device of the previous Aspect wherein said classifying is performed by an operator.

In Aspect 45, there is provided:
The device of Aspect 43 wherein the server is adapted, for said classifying, to use an optical music recognition technique based on a score of the composition, render the recognized score into standard midi form, transcribe the audio channel in the media into standard midi form, and compare midi forms.

In Aspect 46, there is provided:
A device for internet search of a score of a musical composition in correspondence with a media including an audio channel with at least a part of the musical composition, the device adapted to:
receive from a user an identification of the media and a query for a score search in internet;
send the query to a content resolver;
receive results of the search;
identify, in results of the search, first results, each of which has been previously confirmed as pointing at a score with at least a part of the musical composition; and
present to the user all or a part of the first results, if there is at least one first result among the results of the search, articulating them with respect to other results.

In Aspect 47, there is provided:
A device for internet search of a score of a musical composition in correspondence with a media including an audio channel with at least a part of the musical composition, the device adapted to:
receive from a user an identification of the media and a query for a score search in internet;
send the query to a content resolver;
receive results of the search;
identify, in results of the search, first results, each of which has been previously confirmed as pointing at a score with at least a part of the musical composition and has not been confirmed as providing no access for the user to a score with at least a part of the musical composition; and
present to the user all or a part of the first results, if there is at least one first result among the results of the search, articulating them with respect to other results.

In Aspect 48, there is provided:
A server for facilitating an internet search of a score of a musical composition in correspondence with a media including an audio channel with at least a part of the musical composition, the server adapted to:
receive from a user an identification of said media and results of media search,
identify, in results of the search, first results, each of which has been previously confirmed as pointing at a score with at least a part of the musical composition; and
inform the user at least on all or a part of the first results.

In Aspect 49, there is provided:
A server for facilitating an internet search of a score of a musical composition in correspondence with a media including an audio channel with at least a part of the musical composition, the server adapted to:
receive from a user an identification of said media and results of media search,
identify, in results of the search, first results, each of which has been previously confirmed as pointing at a score with at least a part of the musical composition and has not been confirmed as providing no access for the user to a score with at least a part of the musical composition; and
inform the user at least on all or a part of the first results.

In Aspect 50, there is provided:
A device for internet search of audio of a musical composition and a corresponding score, the device adapted to
receive from a user a query for a media search in internet;
receive from the user a query for a score search in internet;
send the query to a content resolver for the media search;.
send the query to a content resolver for the score search;
receive results of the media search;
receive results of the score search;
identify, in results of the media search and of the score search, confirmed matching pair results, in which the media search result has been previously confirmed as pointing at a media with an audio channel with at least a part of the musical composition corresponding to the score search result; and
if at least one confirmed matching pair result is in the results of the search, present to the user all or a part of the confirmed matching pair results, articulating them with respect to other results.

In Aspect 51, there is provided:
A device for internet search of audio of a musical composition and a corresponding score, the device adapted to
receive from a user a query for a media search in internet;
receive from the user a query for a score search in internet;
send the query to a content resolver for the media search;
send the query to a content resolver for the score search;
receive results of the media search;
receive results of the score search;
identify, in results of the media search and of the score search, confirmed matching pair results, in which the media search result has been previously confirmed as pointing at a media with an audio channel with at least a part of the musical composition corresponding to the score search result and has not been confirmed as providing no access for the user; and
if at least one confirmed matching pair result is in the results of the search, present to the user all or a part of the confirmed matching pair results, articulating them with respect to other results.

In Aspect 52, there is provided:
The device of Aspect 50 or 51, wherein only one result from a confirmed matching pair result is presented to the user.

In Aspect 53, there is provided:
A device for internet search of audio of a musical composition and a corresponding score, the device adapted to:
receive from a user a query for a media search and a score search in internet;
send the query to a content resolver for the media search;
send the query to a content resolver for the score search;
receive results of the media search;
receive results of the score search;
identify, in results of the media search and of the score search, confirmed matching pair results, in which the media search result has been previously confirmed as pointing at a media with an audio channel with at least a part of the musical composition corresponding to the score search result; and
if at least one confirmed matching pair result is in the results of the search, present to the user all or a part of the confirmed matching pair results, articulating them with respect to other results.

In Aspect 54, there is provided:
A device for internet search of audio of a musical composition and a corresponding score, the device adapted to:
receive from a user a query for a media search and a score search in internet;
send the query to a content resolver for the media search;
send the query to a content resolver for the score search;
receive results of the media search;
receive results of the score search;
identify, in results of the media search and of the score search, confirmed matching pair results, in which the media search result has been previously confirmed as pointing at a media with an audio channel with at least a part of the musical composition corresponding to the score search result and has not been confirmed as providing no access for the user; and
if at least one confirmed matching pair result is in the results of the search, present to the user all or a part of the confirmed matching pair results, articulating them with respect to other results.

In Aspect 55, there is provided:
A device for facilitating an internet search of audio of a musical composition and a corresponding score, the device adapted to receive from a user results of the media search and the score search;
identify, in results of the media search and of the score search, confirmed matching pair results, in which the media search result has been previously confirmed as pointing at a media with an audio channel with at least a part of the musical composition corresponding to the score search result; and
inform the user at least on all or a part of the confirmed matching pair results.

In Aspect 56, there is provided:
A device for facilitating an internet search of audio of a musical composition and a corresponding score, the device adapted to
receive from a user results of the media search and the score search;
identify, in results of the media search and of the score search, confirmed matching pair results, in which the media search result has been previously confirmed as pointing at a media with an audio channel with at least a part of the musical composition corresponding to the score search result and has not been confirmed as providing no access for the user; and
inform the user at least on all or a part of the confirmed matching pair results.

In Aspect 57, there is provided:
A device for internet search of audio of a musical composition in correspondence with its score, the device adapted to receive from a user an identification of the score and a query for a media search in internet;
send the query and the identification of the score to a classification server, adapted to send the query to a content resolver to perform the search and adapted to identify, in results of the search, first results, each of which has been previously confirmed as pointing at a media with an audio channel with at least a part of the musical composition;
receive and present to the user at least a part of the results of the search from the classification server articulating all or a part of the first results, if there is at least one first result, with respect to other results.

In Aspect 58, there is provided:
A device for internet search of audio of a musical composition in correspondence with its score, the device adapted to
receive from a user an identification of the score and a query for a media search in internet;
send the query to a classification server, adapted to send the query to a content resolver to perform the search and adapted to identify, in results of the search, first results, each of which has been previously confirmed as pointing at a media with an audio channel with at least a part of the musical composition and has not been confirmed as providing no access for the user to media with an audio channel with at least a part of the musical composition;
receive and present to the user at least a part of the results of the search from the classification server articulating all or a part of the first results, if there is at least one first result, with respect to other results.

In Aspect 59, there is provided:
The device of the previous Aspect wherein the device is to receive only the first results, and second results, for each of which no confirmation with regard to the pointer has been previously obtained.

In Aspect 60, there is provided:
A device for facilitating internet search of audio of a musical composition in correspondence with its score, the device adapted to
receive from a user an identification of the score and a query for a media search in internet;
send the query to a content resolver adapted to perform the search and identify, in results of the search, first results, each of which has been previously confirmed as pointing at a media with an audio channel with at least a part of the musical composition;
receive and present to the user at least a part of the results of the search from the content resolver articulating all or a part of the first results, if there is at least one first result, with respect to other results.

In Aspect 61, there is provided:
A device for facilitating internet search of audio of a musical composition in correspondence with its score, the device adapted to
receive from a user an identification of the score and a query for a media search in internet;
send the query to a content resolver adapted to perform the search and identify, in results of the search, first results, each of which has been previously confirmed as pointing at a media with an audio channel with at least a part of the musical composition and has not been confirmed as providing no access for the user to media with an audio channel with at least a part of the musical composition;
receive and present to the user at least a part of the results of the search from the content resolver articulating all or a part of the first results, if there is at least one first result, with respect to other results.

In Aspect 62, there is provided:
A device for internet search of audio of a musical composition in correspondence with its score, the device adapted to:
receive an identification of the score and a query for a media search in internet;
send the query to a content resolver;
receive results of the search;
identify, in results of the search, first results, each of which has been previously confirmed as pointing at a media with an audio channel with at least a part of the musical composition; and store all or a part of the first results, if there is at least one first result.

In Aspect 63, there is provided:
The device of the previous Aspect where the device is adapted to store all or a part of the first results, if there is at least one first result, along with information that the stored results are first results.

In Aspect 64, there is provided:
A server for facilitating an internet search of audio of a musical composition in correspondence with its score, the server adapted to
receive an identification of the score and a collection of pointers pointing at media,
identify, in said collection, second results, for each of which no confirmation on whether a pointer points at a media with an audio channel with at least a part of the musical composition has been previously obtained,
record a second result along with information that the pointer has been classified as the second result and along with the identification of the score.

In Aspect 65, there is provided:
A device for internet search of audio of a musical composition in correspondence with its score, the device adapted to:
receive from a user an identification of the score and a query for a media search in internet;
send the query to a content resolver;
receive results of the search;
send at least a part of the results of the search and the identification of the score to a classification server, receive from the classification server an indication of which of the sent results of the search are first results pointing at media with an audio channel with at least a part of the musical composition.

In Aspect 66, there is provided:
A device for internet search of audio of musical composition and presenting said audio together with a corresponding score, the device adapted to
receive from a user a selection of a musical composition;
send one or more queries for the selected composition to at least one content resolver;
receive results of the one or more searches;
send at least a part of the results of the searches and an identification of a score of the selected musical composition to a classification server,
receive from the classification server an indication of which of the sent results of the searches are first results pointing at media with an audio channel with at least a part of the musical composition.

In Aspect 67, there is provided:
The device of the previous Aspect wherein the musical composition is determined based on a sequence of choices selected by the user in menus presented to the user by the device.

In Aspect 68, there is provided:
The device of the previous Aspect wherein one of the menus presents choices for selecting a composer.

In Aspect 69, there is provided:
A device for internet search of audio of musical composition and presenting said audio together with a corresponding score, the device adapted to
receive from a user a selection of a musical composition;
send to a classification server an identification of a score for the selected musical composition;
receive from the classification server a list of pointers pointing at media with an audio channel with at least a part of the musical composition;
send one or more queries for the selected composition to one or more content resolver;
receive results of the at least one search;
select pointers which appear in the received results of the at least one search and at the same time in the list of pointers received from the classification server.

While the invention has been described with respect to the physical embodiments and Aspects constructed in accordance therewith, it will be apparent to those skilled in the art that various modifications, variations and improvements of the present invention may be made in the light of the above teachings and within the purview of the recited Aspects and claims without departing from the scope of the invention.

In addition, those areas in which it is believed that those ordinary skilled in the art are familiar have not been described herein in order to not unnecessarily obscure the invention described herein. Accordingly, it is to be understood that the invention is not to be limited by the specific illustrated embodiments, but only by the scope of the appended claims.

Features in the dependent Aspects, relating to independent Aspects 1 and 2, may be used with devices defined in other independent Aspects, for example, Aspect 69, whenever possible or appropriate. An appropriate classification server may be claimed for any of the claimed and/or described user devices. A system for search may include a user device and a classification server or portal. Also, it may include one or more content resolver.

1. A device for internet search of audio of a musical composition in correspondence with its score, the device adapted to:
receive from a user an identification of the score and a query for a media search in internet;
send the query to a content resolver;
receive results of the search;
identify, in results of the search, first results, each of which has been previously confirmed as pointing at a media with an audio channel with at least a part of the musical composition; and
present to the user all or a part of the first results, if there is at least one first result, articulating them with respect to other results.

2. The device of claim 1, wherein the device is adapted to identify second results, for each of which no confirmation with regard to the pointer has been previously obtained.

3. The device of claim 2, wherein the device is adapted to identify, among the results of the search, third results, each of which has been previously confirmed as providing no access for the user to media with an audio channel with at least a part of the musical composition.

4. The device of claim 3 adapted to report at least a part of the second results and the identification of the musical score to a classification server for classifying at least a part of the reported results as first results or third results.

5. The device of claim 4 adapted to re-identify at least a part of the reported second results as first or third results based on a response from the classification server.

6. The device of claim 3 adapted to present, for a result selected by the user from the presented results, a corresponding media.

7. The device of claim 3 adapted to present the score of the composition to the user.

8. The device of claim 7 adapted to receive synchronization data for a media from the first results, and play the at least the part of the musical composition from the audio channel of said media in a synchronized manner with presenting a relevant part of the score.

9. The device of claim 8 wherein presenting in the synchronized manner comprises highlighting a measure in the score when this measure is being played.

10. The device of claim 1 wherein the score is in Western staff notation.

11. The device of claim 3 wherein the device is adapted to repeat sending the query for the media search to the content resolver and receive updated results of the search.

12. The device of claim 11, wherein the updated results are different from the previous results due to an upload of a media to internet by a different party.

13. (canceled)

14. A device for internet search of a score of a musical composition in correspondence with a media including an audio channel with at least a part of the musical composition, the device adapted to:
receive from a user an identification of the media and a query for a score search in internet;
send the query to a content resolver;
receive results of the search;
identify, in results of the search, first results, each of which has been previously confirmed as pointing at a score with at least a part of the musical composition; and
present to the user all or a part of the first results, if there is at least one first result among the results of the search, articulating them with respect to other results.

15. A device for internet search of audio of a musical composition and a corresponding score, the device adapted to
receive from a user a query for a media search in internet;
receive from the user a query for a score search in internet;
send the query to a content resolver for the media search;
send the query to a content resolver for the score search;
receive results of the media search;
receive results of the score search;
identify, in results of the media search and of the score search, confirmed matching pair results, in which the media search result has been previously confirmed as pointing at a media with an audio channel with at least a part of the musical composition corresponding to the score search result; and
if at least one confirmed matching pair result is in the results of the search, present to the user all or a part of the confirmed matching pair results, articulating them with respect to other results.
